(19) United States
(12) Patent Application Publication
(10) Pub. No.: US 2014/0188846 A1
(43) Pub. Date: Jul. 3, 2014

(54) DATA LIST CUSTOMIZATION BASED ON SOCIAL RELATIONSHIP

(71) Applicant: EMPIRE TECHNOLOGY DEVELOPMENT LLC, Wilmington, DE (US)

(72) Inventor: Shuichi Kurabayashi, Fujisawa-shi (JP)

(73) Assignee: EMPIRE TECHNOLOGY DEVELOPMENT LLC, Wilmington, DE (US)

(21) Appl. No.: 13/820,716

(22) PCT Filed: Oct. 12, 2012
(86) PCT No.: PCT/US12/59937

§ 371 Date: Mar. 4, 2013

(51) Int. Cl. G06F 17/30

(52) U.S. Cl. CPC G06F 17/30112
USPC 707/722; 707/752

(57) ABSTRACT

Technologies are generally described for a data list customization scheme. In some examples, a data management system may include a communication history analysis unit configured to analyze a communication history of a user, a relationship determination unit configured to calculate relationship indicators for respective acquaintances of the user based at least in part on the communication history of the user analyzed by the communication history analysis unit, and a data list customization unit configured to sort a list of data files based at least in part on the relationship indicators for the respective acquaintances of the user calculated by the relationship determination unit.

### BACKGROUND

Network traffic associated with high-end devices such as smartphones and tablet computers is increasing. The average amount of mobile data traffic per smartphone in the year 2011 was 150 megabytes per month, up from 55 megabytes per month in the year 2010. Further, mobile data traffic per tablet was 517 megabytes per month in 2011, compared to 150 megabytes per month per smartphone.

Much of the increase in mobile data traffic stems from cloud storage services. Users of the high-end devices often store pictures, movies and/or messages associated with their daily lives in the cloud, using services provided by cloud storage service providers, as well as on their devices. For example, the user may upload some contents such as pictures, movies and/or messages from their devices to the cloud, and browse the uploaded contents whenever and wherever they want.

### SUMMARY

In an example, a data management system may include a communication history analysis unit configured to analyze a communication history of a user, a relationship determination unit configured to calculate relationship indicators for respective acquaintances of the user based at least in part on the communication history of the user analyzed by the communication history analysis unit, and a data list customization unit configured to sort a list of data files based at least in part on the relationship indicators for the respective acquaintances of the user calculated by the relationship determination unit.

In another example, a method performed under control of a data management system may include analyzing a communication history of a user, calculating relationship indicators for respective acquaintances of the user based at least in part on the analyzed communication history of the user, and sorting a list of data files based at least in part on the calculated relationship indicators.

In yet another example, a computer-readable storage medium may store thereon computer-executable instructions that, in response to execution, cause an electronic device to perform operations including retrieving from a storage data files associated with a search query input by a user, and customizing a list of the retrieved data files based at least in part on a communication history of the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1(A) and 1(B) schematically show illustrative examples of an electronic device displaying a list of data files, arranged in accordance with at least some embodiments described herein;

FIG. 2 shows examples of diagrams illustrating weight functions for calculating a relationship indicator, arranged in accordance with at least some embodiments described herein;

FIG. 3 shows a schematic block diagram illustrating an example architecture of a data management system for providing a data list customization scheme, arranged in accordance with at least some embodiments described herein;

FIG. 4 shows an example flow diagram of a process for providing a data list customization scheme, arranged in accordance with at least some embodiments described herein;

FIG. 5 illustrates example computer program products that may be utilized to provide a data list customization scheme, arranged in accordance with at least some embodiments described herein; and

FIG. 6 is a block diagram illustrating an example computing device that may be utilized to provide a data list customization scheme, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the drawings, can be arranged, substituted, combined, separated, and designed in a wide variety of different configurations, all of which are explicitly contemplated herein.

This disclosure is generally drawn, inter alia, to methods, apparatuses, systems, devices, and computer program products related to a data list customization scheme. Further, technologies are herein generally described for customizing a list of data files based at least in part on social relationship of a user.

In some examples, a user of an electronic device may browse at least some of data files stored in a storage device or component. The storage device or component may be a component of the electronic device or be a cloud-based storage device or component provided and/or operated by a cloud storage service provider. Examples of the electronic device may include, but are not limited to, a smartphone, a mobile phone, a personal digital assistant (PDA), a tablet, a laptop computer, a desktop computer, and any other devices that may store data files and/or access to an external device or server via any network.

In some examples, when the user enters a search query, the electronic device may retrieve from the storage the data files associated with the search query, and provide the user with a list of the retrieved data files. In such cases, a data management system may customize a list of the retrieved data files based at least in part on a communication history of the user, by analyzing the communication history of the user, calculating relationship indicators for respective acquaintances of the user based at least in part on the communication history, and sorting the list of data files based at least in part on the relationship indicators for the respective acquaintances. The communication history may be relevant to a communication history recorded in the electronic device, and/or a communication history of an account (e.g., an e-mail account, a phone account, a social network service (e.g., Facebook®) account) to which the user is subscribed. The data management system may be implemented as an application run on the electronic device, program modules of the electronic device, a cloud-based application accessed by the electronic device, and/or hardware modules of the electronic device.

By way of example, but not limitation, it may be assumed that the user receives from one of the user's acquaintances (e.g., a first acquaintance) a short message service (SMS) message requesting to send a document file related to a nanotechnology which the user and the first acquaintance prepared together. In such cases, the data management system may increase the relationship indicator for the first acquaintance based on the reception of the SMS message from the first acquaintance. Then, when the user enters a search query “nanotechnology,” the data management system may provide the user with a list of document file related to the nanotechnology, in which the document files associated with the first acquaintance are in high rank.

By way of another example, but not limitation, it may be assumed that the user receives from another acquaintance (e.g., a second acquaintance) a social network service (SNS) message regarding a meeting of acquaintances from a particular place, e.g., the city of Kyoto. In such cases, the data management system may increase the relationship indicator for the second acquaintance based on the reception of the SNS message from the second acquaintance. Then, when the user wishes to browse photos taken with the second acquaintance in Kyoto, and enters a search query “Kyoto,” the data management system may provide the user with a list of photos taken in Kyoto, in which the photos tagged with the second acquaintance are in high rank.

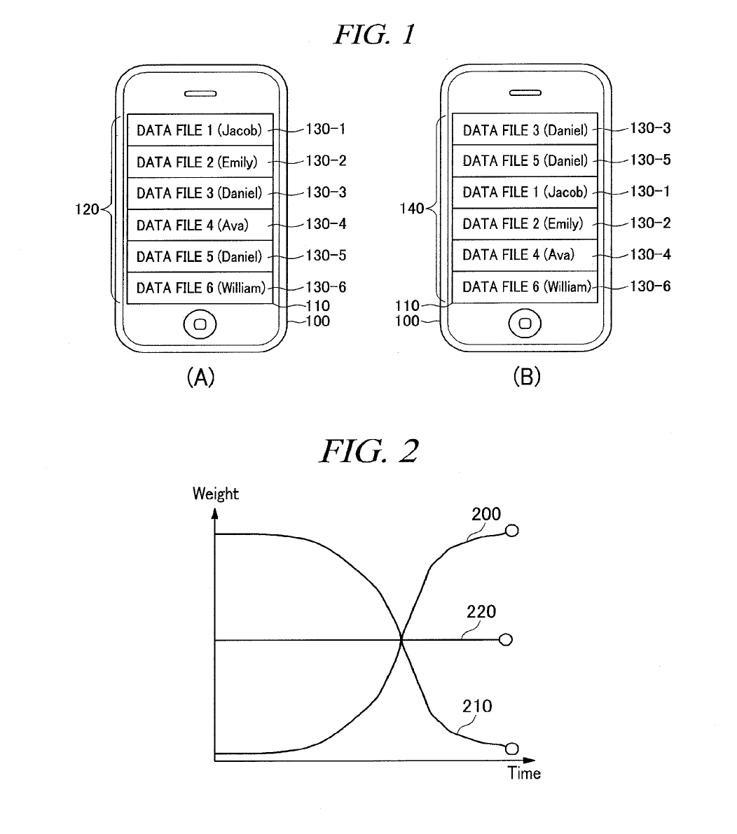

FIGS. 1(A) and 1(B) schematically show illustrative examples of an electronic device displaying a list of data files, arranged in accordance with at least some embodiments described herein.

As depicted in FIG. 1(A), when a user enters a search query to browse data files associated with the search query, an electronic device 100 may present on a display 110 a list 120 of data files 130-1, 130-2, 130-3, 130-4, 130-5 and 130-6, which are associated with the search query and stored in a storage device or component. The storage device or component may be a component of electronic device 100, or a cloud-based storage device provided and/or operated by a cloud storage service provider. Examples of electronic device 100 may include, but are not limited to, a smartphone, a mobile phone, a personal digital assistant (PDA), a tablet, a laptop computer, a desktop computer, etc. Further, examples of the data files may include, but are not limited to, image files, audio files, video files, document files, message files, etc.

In some embodiments, a data management system may sort an order of data files 130-1, 130-2, 130-3, 130-4, 130-5 and 130-6 to be presented based at least in part on the user's social relationship relative to his/her acquaintances, and provide the user with a customized list 140 as depicted in FIG. 1(B). By way of example, but not limitation, the data management system may be implemented as an application run on electronic device 100, program modules of electronic device 100, a cloud-based application accessed by electronic device 100, and/or hardware modules of electronic device 100.

In some embodiments, the data management system may analyze a communication history of the user. By way of example, but not limitation, the data management system may detect a number of communications with each acquaintance of the user, and/or times of the respective communications with each of the acquaintances of the user. For example, the data management system may detect how frequently and/or when the user has had phone calls, and/or has exchanged e-mails, SMS messages, and/or SNS messages with each of the acquaintances of the user.

In some embodiments, the data management system may calculate relationship indicators for respective acquaintances of the user based at least in part on the communication history of the user. The relationship indicator for one of the acquaintances, person p, may be defined as follows:

$$R ( p ) = {\sum }_{i = 0}^{n} t ( {p}_{i} ) ,$$

in which R(p) denotes the relationship indicator for person p; pᵢ denotes i-th communication between the user and person p; n is a total number of communications between the user and person p; and t(pᵢ) denotes a predetermined weight function, which will be described with reference to FIG. 2.

FIG. 2 shows examples of diagrams illustrating weight functions for calculating a relationship indicator, arranged in accordance with at least some embodiments described herein.

In some embodiments, the data management system may determine a weight function for calculating a relationship indicator between a user and one of his/her acquaintances, based at least in part on the user's preference, i.e., based at least in part on the user's setting. By way of example, but not limitation, when the user considers that recent communications are more important than communications further in the past, the data management system may adopt a weight function 200 shown in FIG. 2. By way of another example, but not limitation, when the user considers that communications further in the past are more important than recent communications, the data management system may adopt a weight function 210 shown in FIG. 2. By way of yet another example, but not limitation, when the user wants to treat equally recent communications and past communications, the data management system may adopt a weight function 220 shown in FIG. 2.

Referring to FIGS. 1(A) and 1(B) again, in some embodiments, the data management system may sort or customize an order of data files 130-1, 130-2, 130-3, 130-4, 130-5 and 130-6 to be presented, in descending order of the relationship indicators for the respective acquaintances associated with the data files. By way of example, but not limitation, the data management system may detect association between the acquaintances and the data files based at least in part on metadata of the data files.

By way of example, but not limitation, when the data management system determines that the relationship indicator for acquaintance Daniel has a highest value, and the relationship indicators for acquaintances Jacob, Emily, Ava and William follow in turn, the data management system may determine the order of data files to be presented to the user as data files 130-3 and 130-5 associated with Daniel, data file 130-1 associated with Jacob, data file 130-2 associated with Emily, data file 130-4 associated with Ava, and data file 130-6 associated with William. In such cases, electronic device 100 may present on display 110 customized list 140 as depicted in FIG. 1(B). That is, the data files are presented in descending order of relationship indicators.

Although it is illustrated in the example that electronic device 100 retrieves six data files from the storage and provides the user with the list of the six data files, one skilled in the art will appreciate that electronic device 100 may retrieve any number of data files and provide the user with the list thereof.

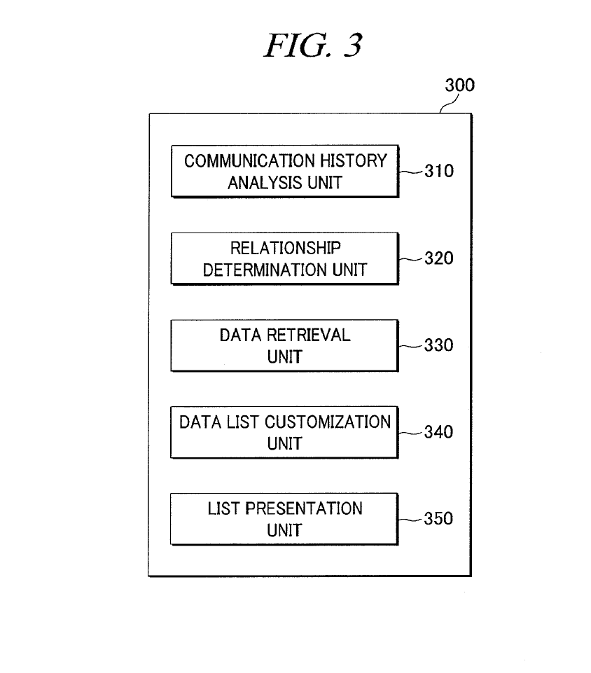

FIG. 3 shows a schematic block diagram illustrating an example architecture of a data management system for providing a data list customization scheme, arranged in accordance with at least some embodiments described herein.

As depicted, a data management system 300 may include a communication history analysis unit 310, a relationship determination unit 320, a data retrieval unit 330, a data list customization unit 340, and a list presentation unit 350. Although illustrated as discrete components, various components may be divided into additional components, combined into fewer components, or eliminated while being contemplated within the scope of the disclosed subject matter.

Communication history analysis unit 310 may be configured to analyze a communication history of a user. In some embodiments, communication history analysis unit 310 may detect a number of communications with each acquaintance of the user, and/or times of the respective communications with each of the acquaintances. By way of example, but not limitation, communication history analysis unit 310 may detect the acquaintances of the user by referring to a contact list of the user. Further, by way of example, but not limitation, the communications with each of the acquaintances of the user may include at least one of phone calls, e-mail exchanges, short message service (SMS) message exchanges, and social network service (SNS) message exchanges.

Relationship determination unit 320 may be configured to calculate a relationship indicator for each of the acquaintances of the user based at least in part on the communication history of the user analyzed by communication history analysis unit 310. In some embodiments, relationship determination unit 320 may be configured to increase the relationship indicator for a respective one of the acquaintances as the number of communications with the respective one of the acquaintances increases. In some alternative embodiments, relationship determination unit 320 may be configured to increase the relationship indicator for a respective one of the acquaintances as the number of communications with the respective one of the acquaintances increases within a predetermined period of time. By way of example, but not limitation, the predetermined period of time may include a time period set by the user, a recent one week time period, a recent one month time period, and so on, as customized by the user or an administrator of data management system 300.

Data retrieval unit 330 may be configured to retrieve from a storage component or device at least some of multiple data files stored in the storage component or device. In some embodiments, data retrieval unit 330 may retrieve from the storage component or device the data files associated with a search query input by the user. The storage component or device may be a component of an electronic device (e.g., electronic device 100) of the user, or a cloud-based storage device provided and/or operated by a cloud storage service provider.

Data list customization unit 340 may be configured to sort a list of the retrieved data files based at least in part on the relationship indicators for the respective acquaintances of the user calculated by relationship determination unit 320. By way of example, but not limitation, data list customization unit 340 may sort the list of the retrieved data files in descending order of the relationship indicators for the respective acquaintances associated with the data files.

List presentation unit 350 may be configured to provide the user with the list of the data files retrieved by data retrieval unit 330 and sorted by data list customization unit 340.

As such, data management system 300 may provide the user with the list of the data files customized based on the user's social relationship, thereby allowing the user to easily access one of the multiple data files he/she wants to browse.

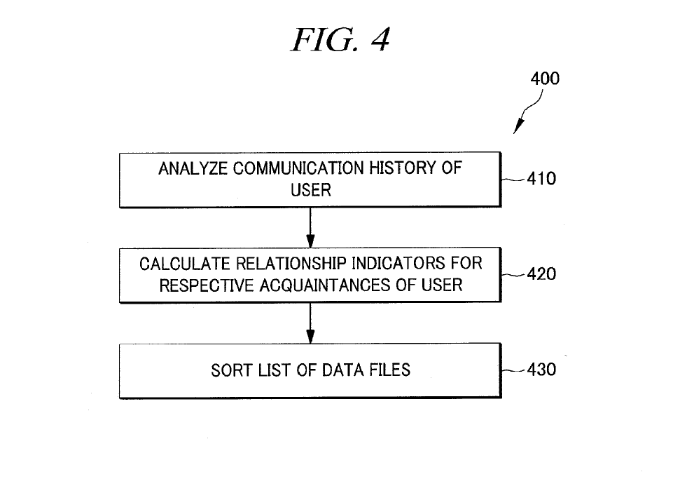

FIG. 4 shows an example flow diagram of a process for providing a data list customization scheme, arranged in accordance with at least some embodiments described herein.

The process in FIG. 4 may be implemented in a data management system, such as data management system 300 including communication history analysis unit 310, relationship determination unit 320, data retrieval unit 330, data list customization unit 340 and list presentation unit 350, described above. An example process 400 may include one or more operations, actions, or functions as illustrated by one or more blocks 410, 420 and/or 430. Although illustrated as discrete blocks, various blocks may be divided into additional blocks, combined into fewer blocks, or eliminated, depending on the desired implementation. Processing may begin at block 410.

At block 410 (Analyze Communication History of User), the data management system may analyze a communication history of a user. In some embodiments, the data management system may detect at least one of times and numbers of communications with respective acquaintances of the user, including, but not limited to, at least one of phone calls, e-mail exchanges, short message service (SMS) message exchanges, and social network service (SNS) message exchanges. Processing may continue from block 410 to block 420.

At block 420 (Calculate Relationship Indicators for Respective Acquaintances of User), the data management system may calculate relationship indicators for the respective acquaintances of the user based at least in part on the analyzed communication history of the user. In some embodiments, the relationship indicator for a respective one of the acquaintances may increase as the number of communications with the respective one of the acquaintances increases. In some alternative embodiments, the relationship indicator for a respective one of the acquaintances may increase as the number of communications with the respective one of the acquaintances increases within a predetermined period of time. Processing may continue from block 420 to block 430.

At block 430 (Sort List of Data Files), the data management system may sort a list of data files based at least in part on the calculated relationship indicators, for example, in descending order of the relationship indicators for the acquaintances associated with the data files. In some embodiments, the data management system may retrieve from a storage component or device the data files associated with a search query input by the user, and sort the list of the retrieved data files.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

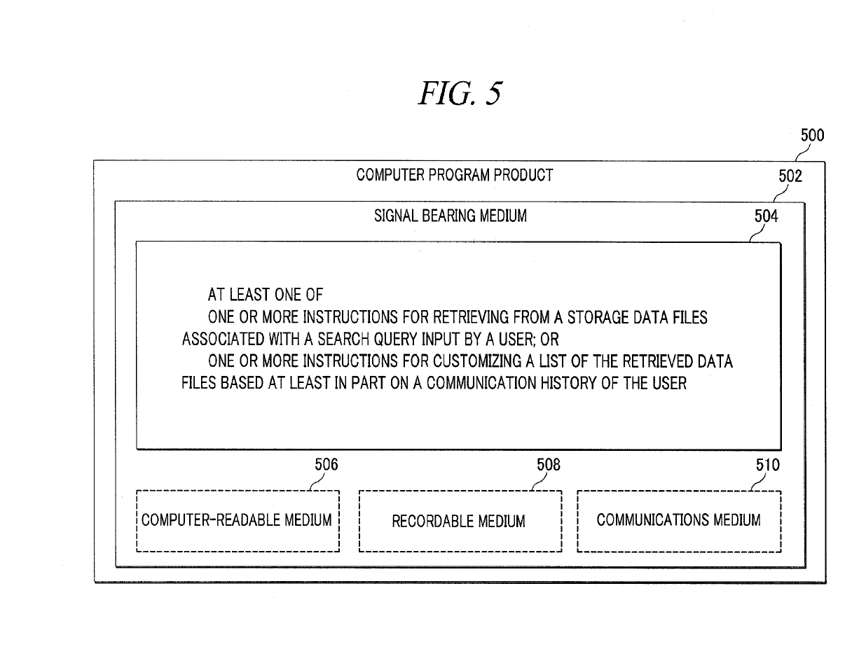

FIG. 5 illustrates example computer program products that may be utilized to provide a data list customization scheme, arranged in accordance with at least some embodiments described herein.

Program product 500 may include a signal bearing medium 502. Signal bearing medium 502 may include one or more instructions 504 that, when executed by, for example, a processor, may provide the functionality described above with respect to FIGS. 1-4. By way of example, instructions 504 may include: one or more instructions for retrieving from a storage data files associated with a search query input by a user; or one or more instructions for customizing a list of the retrieved data files based at least in part on a communication history of the user. Thus, for example, referring to FIG. 3, data management system 300 may undertake one or more of the blocks shown in FIG. 4 in response to instructions 504.

In some implementations, signal bearing medium 502 may encompass a computer-readable medium 506, such as, but not limited to, a hard disk drive, a CD, a DVD, a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, program product 500 may be conveyed to one or more modules of data management system 300 by an RF signal bearing medium 502, where the signal bearing medium 502 is conveyed by a wireless communications medium 510 (e.g., a wireless communications medium conforming with the IEEE 802.11 standard).

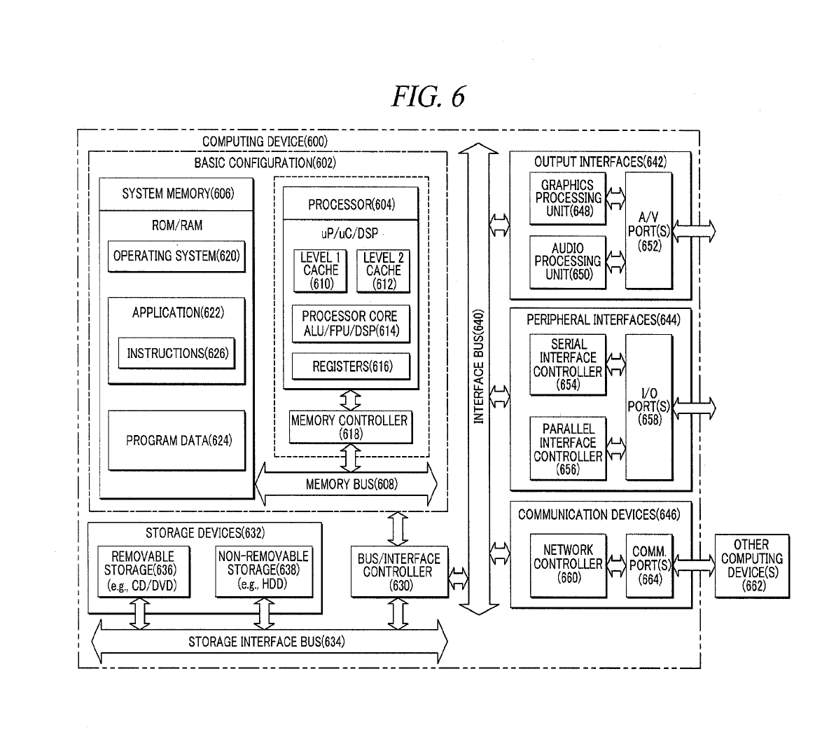

FIG. 6 is a block diagram illustrating an example computing device that may be utilized to provide a data list customization scheme, arranged in accordance with at least some embodiments described herein.

In these examples, elements of computing device 600 may be arranged or configured for an electronic device. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include instructions 626 that may be arranged to perform the functions as described herein including the actions described with respect to the data management system 300 architecture as shown in FIG. 3 or including the actions described with respect to the flow charts shown in FIG. 4. In some examples, application 622 may be arranged to operate with program data 624 on an operating system 620 such that implementations for instructions for a computing system as described herein.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more AN ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A data management system, comprising:
a communication history analysis unit configured to analyze a communication history of a user;
a relationship determination unit configured to calculate relationship indicators for respective acquaintances of the user based at least in part on the communication history of the user analyzed by the communication history analysis unit; and
a data list customization unit configured to sort a list of data files based at least in part on the relationship indicators for the respective acquaintances of the user calculated by the relationship determination unit,
wherein the data files include at least one of image files, audio files, video files, document files, and message files.

2. The data management system of claim 1, wherein the communication history analysis unit is further configured to detect a number of communications with each of the acquaintances of the user.

3. The data management system of claim 2, wherein the communications with each of the acquaintances of the user include at least one of phone calls, e-mail exchanges, short message service (SMS) message exchanges, and social network service (SNS) message exchanges.

4. The data management system of claim 2, wherein the relationship determination unit is further configured to increase the relationship indicator for a respective one of the acquaintances as the number of communications with the respective one of the acquaintances increases.

5. The data management system of claim 2, wherein the communication history analysis unit is further configured to detect times of the communications with each of the acquaintances of the user.

6. The data management system of claim 5, wherein the relationship determination unit is further configured to increase the relationship indicator for a respective one of the acquaintances as the number of communications with the respective one of the acquaintances increases within a predetermined period of time.

7. The data management system of claim 1, wherein the data list customization unit is further configured to sort the list of the data files in descending order of the relationship indicators for the respective acquaintances associated with the data files.

8. The data management system of claim 1, further comprising:
a data retrieval unit configured to retrieve the data files from a storage; and
a list presentation unit configured to provide the user with the list of the data files retrieved by the data retrieval unit.

9. The data management system of claim 8, wherein the storage is operated by a cloud storage service provider.

10. (canceled)

11. A method performed under control of a data management system, comprising:
analyzing a communication history of a user;
calculating relationship indicators for respective acquaintances of the user based at least in part on the analyzed communication history of the user; and
sorting a list of data files based at least in part on the calculated relationship indicators,
wherein the data files include at least one of image files, audio files, video files, document files, and message files.

12. The method of claim 11, wherein the analyzing includes detecting at least one of times and numbers of communications with the respective acquaintances of the user.

13. The method of claim 12, wherein the communications with the respective acquaintances of the user include at least one of phone calls, e-mail exchanges, short message service (SMS) message exchanges, and social network service (SNS) message exchanges.

14. The method of claim 12, wherein the relationship indicator for a respective one of the acquaintances increases as the number of communications with the respective one of the acquaintances increases.

15. The method of claim 12, wherein the relationship indicator for a respective one of the acquaintances increases as the number of communications with the respective one of the acquaintances increases within a predetermined period of time.

16. The method of claim 11, wherein the sorting includes sorting the list of the data files in descending order of the relationship indicators for the acquaintances associated with the data files.

17. The method of claim 11, further comprising:
receiving a search query from the user;
retrieving from a storage the data files associated with the search query; and
generating the list of the retrieved data files.

18. The method of claim 11, further comprising:
providing the user with the sorted list of the data files.

19. (canceled)

20. A computer-readable storage medium having stored thereon computer-executable instructions that, in response to execution, cause an electronic device to perform operations, comprising:
retrieving from a storage data files associated with a search query input by a user; and
customizing a list of the retrieved data files based at least in part on a communication history of the user,
wherein the data files include at least one of image files, audio files, video files, document files, and message files.

21. The computer-readable storage medium of claim 20, wherein the customizing includes sorting the list of the retrieved data files based at least in part on an amount of communication between the user and the user's acquaintance who is associated with each of the retrieved data files.
